(19) United States
(12) Patent Application Publication
(10) Pub. No.: US 2006/0001819 A1
(43) Pub. Date: Jan. 5, 2006

(54) Display device

(76) Inventors: Ho-Suk Maeng, Seoul (KR); Soong-Yong Joo, Seongnam-si (KR); Chul-Ho Kim, Seoul (KR); Kee-Chan Park, Suwon-si (KR); Cheol-Min Kim, Seoul (KR); Tae-Hyeong Park, Yongin-si (KR); Kook-Chul Moon, Yongin-si (KR); II-Gon Kim, Seoul (KR); Chi-Woo Kim, Seoul (KR); Jin-Hyuk Yun, Seoul (KR)

Correspondence Address: CANTOR COLBURN, LLP, 55 GRIFFIN ROAD SOUTH, BLOOMFIELD, CT, 06002, US

(21) Appl. No.: 11/159,895

(22) Filed: Jun. 23, 2005

(30) Foreign Application Priority Data
Jun. 23, 2004 (KR) 10-2004-0046981
Jun. 23, 2004 (KR) 10-2004-0046982
Jun. 23, 2004 (KR) 10-2004-0046983

(51) Int. Cl. G02F 1/1345

(52) U.S. Cl. 349/149

(57) ABSTRACT

A display device includes a circuit board provided with signal lines, a first and a second panel unit separately attached to the circuit board and each provided with pixels comprising switching elements, and a driving circuit chip mounted on the circuit board and driving the first and the second panel units.

This application claims priority to Korean Patent Application Nos. 2004-0046981 filed on Jun. 23, 2004, 2004-0046982 filed on Jun. 23, 2004 and 2004-0046983 filed on Jun. 23, 2004, and all the benefits accruing therefrom under 35 U.S.C §119, and the contents of which in their entirety are herein incorporated by reference.

### BACKGROUND OF THE INVENTION

(a) Field of the Invention

The present invention relates to a display device.

(b) Description of Related Art

Recently, flat panel display devices have been widely developed such as, for example, organic electroluminescence display (OLED) devices, plasma display panel (PDP) devices and liquid crystal display (LCD) devices. The flat panel display devices are popular replacements for heavy and large cathode ray tube (CRT) display devices.

The PDP devices display characters or images using plasma generated by gas-discharge, and the OLED devices display characters or images using electric field light-emitting characteristics of specific organics or high molecules. The LCD devices display desired images by applying an electric field to a liquid crystal layer disposed between two panels and regulating a strength of the electric field to adjust a transmittance of light passing through the liquid crystal layer.

A special type from among the above mentioned display devices, a dual display device is being vigorously developed. Dual display devices may be employed in small and medium sized display devices. Dual display devices are capable of displaying images at each of two panel units disposed at opposite sides of the dual display devices.

The two panel units of the dual display devices include a main panel unit mounted on an inner side and a subsidiary panel unit mounted on an outer side of the display device. The dual display device further includes a driving flexible printed circuit (FPC) film provided with wires to transmit input signals from external devices, an auxiliary FPC connecting the main panel unit to the subsidiary panel unit, and an integrated chip which controls the above-described elements.

The integrated chip generates control signals and driving signals for controlling the main panel unit and the subsidiary panel unit, which is generally mounted as a COG (chip on glass) type.

In such a case, the auxiliary FPC and the driving FPC are attached to an upper side and a lower side of the main panel unit, respectively, and the subsidiary panel unit is attached to the auxiliary FPC.

The main panel unit needs a blind space for mounting the integrated chip and attaching the driving FPC at the lower side of the main panel unit and a blind space for attaching the auxiliary FPC at the upper side of the main panel unit. Furthermore, processes for mounting the integrated chip and for attaching the driving and auxiliary FPCs need to be performed. These processes cause a size of the display device to be increased due to the blind spaces for attachment. Additionally, the processes for mounting the integrated chip and for attaching the driving and auxiliary FPCs are complicated and manufacturing cost is increased.

### SUMMARY OF THE INVENTION

An object of the present invention is to provide a display device capable of solving such conventional problems.

A display device is provided, which includes a circuit board provided with signal lines a first and a second panel unit separately attached to the circuit board and provided with pixels comprising switching elements, and a driving circuit chip mounted on the circuit board and driving the first and the second panel units.

A display device is provided, which includes a circuit board provided with signal lines, a first and a second panel unit separately attached to the circuit board and provided with pixels comprising switching elements, and a driving circuit chip mounted on the circuit board and driving the first and the second panel units. The circuit board includes a first pad group, a second pad group, a third pad group and a fourth pad group. The first pad group is disposed in an overlapping area of the first panel unit and the circuit board. The second and a third pad groups are disposed in an overlapping area of the driving circuit chip and the circuit board The fourth pad group is disposed in an overlapping area of the second panel unit and the circuit board. The second pad group is connected to the first pad group and a portion of the second pad group is connected to the fourth pad group.

A display device is provided, which includes a circuit board provided with signal lines, a first and a second panel unit separately attached to the circuit board and provided with pixels comprising switching elements, and a driving circuit chip mounted on the circuit board and driving the first and the second panel units. The circuit board includes a first pad group disposed in an overlapping area of the first panel unit and the circuit board, a second and a third pad groups disposed in an overlapping area of the driving circuit chip and the circuit board, and a fourth pad group disposed in an overlapping area of the second panel unit and the circuit board. A portion of the third pad group is connected to the fourth pad group.

A display device is provided, which includes a circuit board provided with signal lines, a first and a second panel unit separately attached to the circuit board and provided with pixels comprising switching elements, and a driving circuit chip mounted on the first panel unit and driving the first and the second panel units.

### BRIEF DESCRIPTION OF THE DRAWINGS

The present invention will become more apparent by describing exemplary embodiments thereof in detail with reference to the accompanying drawings in which:

FIG. 1 is a schematic drawing of a display device according to an exemplary embodiment of the present invention;

FIG. 2 is a schematic drawing of a display device according to another exemplary embodiment of the present invention;

FIG. 3 is a block diagram of a display device according to an exemplary embodiment of the present invention;

FIG. 4 is an equivalent circuit diagram of a pixel of an LCD device according to an exemplary embodiment of the present invention;

FIG. 5 is an enlarged view of the display device shown in FIG. 1; and

FIG. 6 is an enlarged view of the display device shown in FIG. 2.

### DETAILED DESCRIPTION OF THE INVENTION

The present invention will be described more fully hereinafter with reference to the accompanying drawings, in which exemplary embodiments of the invention are shown. This invention may, however, be embodied in many different forms and should not be construed as limited to the embodiments set forth herein.

In the drawings, thicknesses of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present.

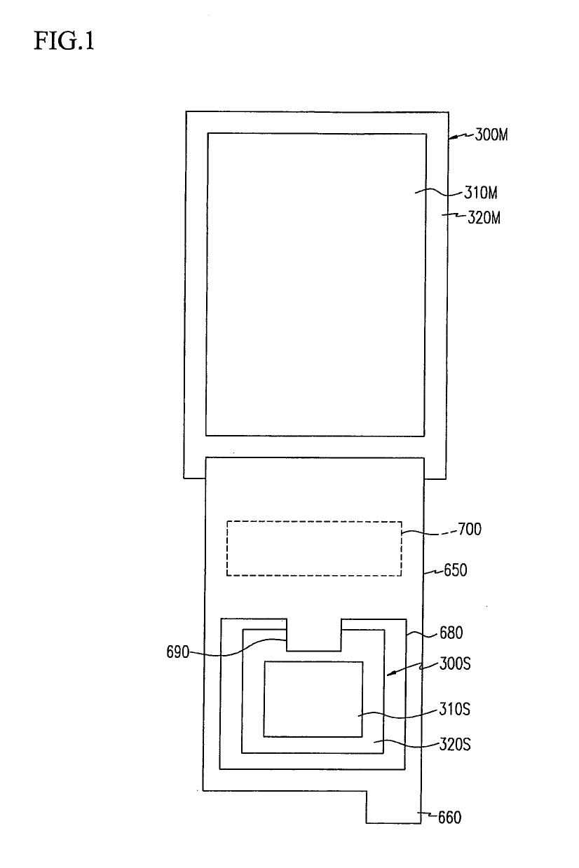

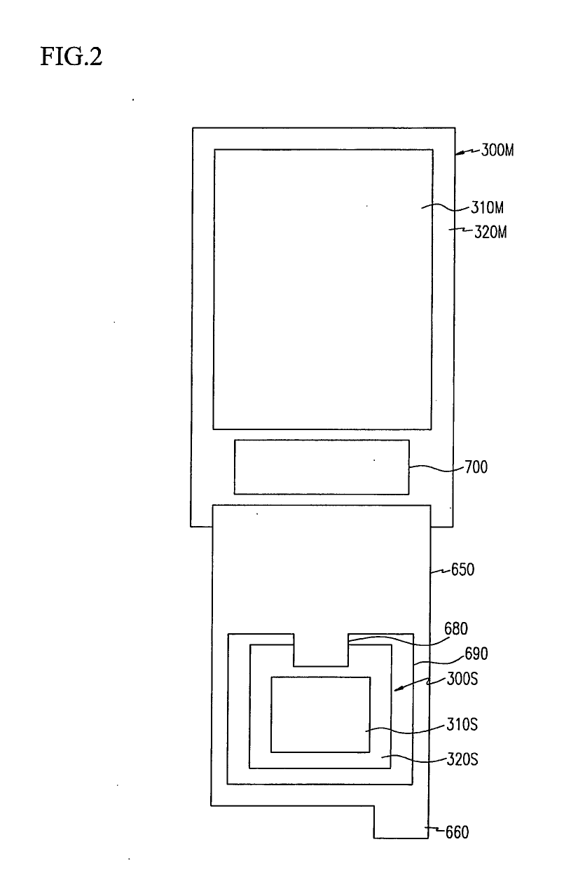

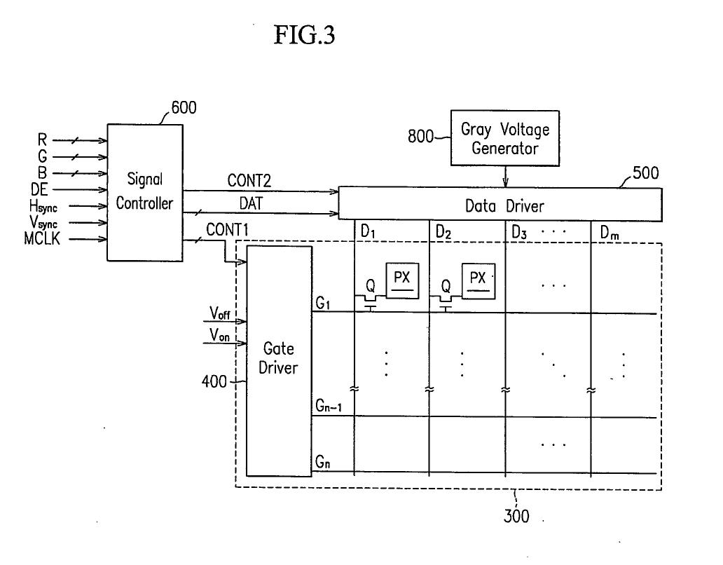

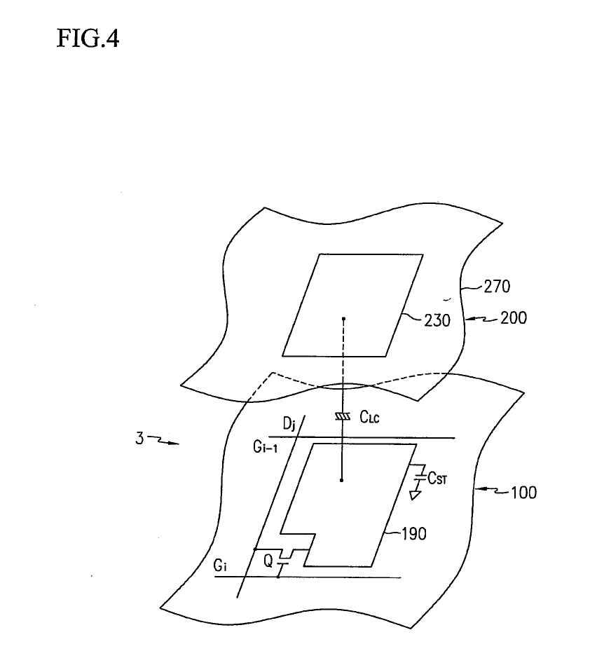

FIG. 1 is a schematic drawing of a display device according to an exemplary embodiment of the present invention. FIG. 2 is a schematic drawing of a display device according to another exemplary embodiment of the present invention. FIG. 3 is a block diagram of a display device according to an exemplary embodiment of the present invention. FIG. 4 is an equivalent circuit diagram of a pixel of a liquid crystal display (LCD) device according to an exemplary embodiment of the present invention.

Referring to FIG. 1, a display device according to an exemplary embodiment of the present invention includes two panel units such as a main panel unit 300M and a subsidiary panel unit 300S, and a flexible printed circuit (FPC) 650 attached thereto and an integrated chip (IC) 700 mounted on the FPC 650.

The FPC 650 is attached to one side of the main panel unit 300M and has an aperture 680 positioned at a side of the FPC 650 that is opposite to the IC 700. The FPC 650 further has a projection 690 projected into the aperture 680, and the subsidiary panel unit 300S is attached to the projection 690 and is located in the aperture 680. In this way, it is possible to save manufacturing cost by not using a separate FPC for attaching the subsidiary panel unit 300S.

The FPC 650 has a connector 660 where signals are inputted from an external device. The connector 660 is disposed at a lower side of the FPC 650. The FPC 650 further includes a plurality of signal lines (not shown) for electrically connecting the IC 700 to the main and subsidiary panel units 300M and 300S. The signal lines form pads (not shown) in connection points of the IC 700 and attachment points of the main and subsidiary panel units 300M and 300S by substantial enlargement thereof.

The main and subsidiary panel units 300M and 300S include main and subsidiary display areas 310M and 310S, which form a screen, and peripheral areas 320M and 320S, respectively. The peripheral areas 320M and 320S may include light-blocking layers (not shown) (called a “black matrix”) for blocking light. The FPC 650 is attached to the peripheral areas 320M and 320S.

Referring to FIG. 2, a display device according to another exemplary embodiment of the present invention includes two panel units such as the main panel unit 300M and the subsidiary panel unit 300S, and the FPC 650 attached to the main and subsidiary panel units 300M and 300S. Unlike FIG. 1, the IC 700 is mounted on the main panel unit 300M, instead of on the FPC 650.

The FPC 650 is attached to one side of the mail panel unit 300M and has the aperture 680 positioned at an opposite side of the main panel unit 300M with respect to the IC 700. The FPC 650 further has the projection 690 projected into the aperture 680, and the subsidiary panel unit 300S is attached to the projection 690 and is located in the aperture 680. In this way, it is possible to save manufacturing cost by not using a separate FPC for attaching the subsidiary panel unit 300S.

The FPC 650 includes the connector 660 where signals are inputted from an external device, and further includes a plurality of signal lines (not shown) for connecting the IC 700 to the main and subsidiary panel units 300M and 300S. The connector 660 is disposed at a lower side of the FPC 650. The signal lines form pads (not shown) in the connection points of the IC 700 and the attachment points of the main and subsidiary panel units 300M and 300S by substantial enlargement thereof.

The main and subsidiary panel units 300M and 300S include the main and subsidiary display areas 310M and 310S, which form the screen, and the peripheral areas 320M and 320S, respectively. The peripheral areas 320M and 320S may include light-blocking layers (not shown) (called the “black matrix”) for blocking light. The FPC 650 is attached to the peripheral areas 320M and 320S.

As shown in FIG. 3, each of the main and subsidiary panel units 300M and 300S (each represented generally by panel unit 300) includes a plurality of display signal lines G1-Gn and D1-Dm including gate lines G1-Gn and data lines D1-Dm, pixels connected to the gate lines G1-Gn and data lines D1-Dm and arranged substantially in a matrix, and a gate driver 400 supplying signals to the gate lines G1-Gn. Most of the pixels and the display signal lines G1-Gn and D1-Dm are disposed in the main and subsidiary display areas 310M and 310S, and the gate driver 400 is disposed in the peripheral areas 320M and 320S.

Referring to FIG. 4, an upper panel 200 is made smaller than a lower panel 100, such that the lower panel 100 has an exposed area into which the data lines D1-Dm are extended to be electrically connected to a data driver 500. The gate lines G1-Gn are extended into the peripheral areas 320M and 320S to be connected to the gate driver 400.

The gate lines G1-Gn transmit gate signals (called scanning signals), extend substantially in a row direction and are substantially parallel to each other. The data lines D1-Dm transmit data signals, extend substantially in a column direction and are substantially parallel to each other. The display signal lines G1-Gn and D1-Dm form pads at the connection point of the FPC 650 by substantial enlargement thereof. The main and subsidiary panel units 300M and 300S and the FPC 650 are connected by means of an anisotropic conductive film for electrical connection of the pads.

Each pixel includes a switching element Q electrically connected to the display signal lines G1-Gn and D1-Dm and a pixel circuit Px connected to the switching element Q.

The switching element Q is provided on the lower panel 100 and has three terminals: a control terminal electrically connected to one of the gate lines G1-Gn (for example, Gi); an input terminal electrically connected to one of the data lines D1-Dm (for example, Dj); and an output terminal electrically connected to the pixel circuit Px. The switching element Q may be, for example, a thin film transistor, and may include, for example, poly-silicon or amorphous silicon.

As shown in FIG. 4, in an LCD device, which is an example of a flat panel display device, the panel unit 300 includes the lower panel 100, the upper panel 200, a liquid crystal (LC) layer 3 interposed between the lower and upper panels 100 and 200. The display signal lines G1-Gn and D1-Dm and the switching element Q are provided on the lower panel 100. The pixel circuit Px of the LCD device includes an LC capacitor C_{LC} and a storage capacitor C_{ST}. The storage capacitor C_{ST} may be omitted if unnecessary.

The LC capacitor C_{LC} includes a pixel electrode 190 on the lower panel 100, a common electrode 270 on the upper panel 200, and the LC layer 3 as a dielectric between the pixel and common electrodes 190 and 270. The pixel electrode 190 is electrically connected to the switching element Q, and the common electrode 270 covers an entire surface of the upper panel 100 and is supplied with a common voltage Vcom. Alternatively, both the pixel electrode 190 and the common electrode 270, which have shapes of bars or stripes, are provided on the lower panel 100.

The storage capacitor C_{ST} is an auxiliary capacitor for the LC capacitor C_{LC}. The storage capacitor C_{ST} includes the pixel electrode 190 and a separate signal line (not shown), which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For a color display, each pixel uniquely represents one of three primary colors such as red, green and blue colors or sequentially represents the three primary colors in time, thereby obtaining a desired color. FIG. 4 shows an example in which each pixel includes a color filter 230 representing one of the three primary colors in an area of the upper panel 200 facing a corresponding pixel electrode 190. Alternatively, the color filter 230 is provided on or under the pixel electrode 190 on the lower panel 100.

A pair of polarizers (not shown) polarizing light are attached on outer surfaces of the lower and upper panels 100 and 200 of the panel unit 300.

The gate driver 400 is electrically connected to the gate lines G1-Gn of the panel unit 300 and synthesizes a gate-on voltage Von and a gate off voltage Voff to generate gate signals for application to the gate lines G1-Gn.

The IC 700 is supplied with external signals via signal lines provided on the connector 660 and the FPC 650 and supplies processed signals for control of the main panel unit 300M and the subsidiary panel unit 300S to the FPC 650. The IC 700 includes a gray voltage generator 800, the data driver 500 and a signal controller 600.

The gray voltage generator 800 generates two sets of gray voltages related to a transmittance of the pixels. The gray voltages in a first set have a positive polarity with respect to the common voltage Vcom, while the gray voltages in a second set have a negative polarity with respect to the common voltage Vcom.

The data driver 500 is electrically connected to the data lines D1-Dm of the panel unit 300 and applies data voltages selected from the gray voltages supplied from the gray voltage generator 800 to the data lines D1-Dm. The signal controller 600 controls operation of the gate and data drivers 400 and 500.

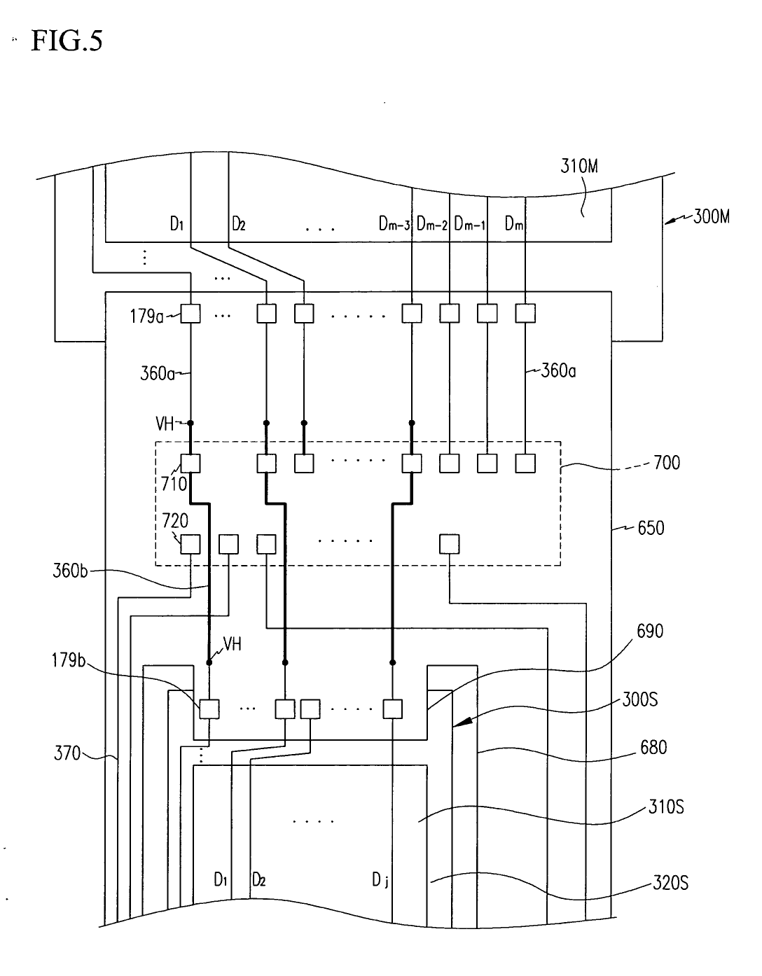

FIG. 5 is an enlarged view of the display device shown in FIG. 1.

An area shown with a dotted line is a part for mounting the IC 700 and represents that the IC 700 is attached to a back side of the FPC 650. Further, among signal lines shown in the FPC 650, thick solid lines represent signal lines disposed on a front side and thin solid lines represent signal lines disposed on the back side of the FPC 650, for example. In this case, it is noted that thicknesses of the signal lines disposed on the front and back sides are not necessarily different.

Input pads 720 and output pads 710 are disposed in an area of the IC 700. Input lines 370 are connected to the input pads 720 and transmit signals from the connector 660 shown in FIG. 1 to the input pads 720.

First and second output lines 360a and 360b are connected to the output pads 710. The first output lines 360a extend toward the main panel unit 300M, some of which are connected to first data pads 179a via through holes VH, and others of which are directly connected to the main panel unit 300M. The first data pads 179a are connected to the data lines D1-Dm. A first data pad 179a positioned closest to an edge of the FPC 650 (i.e. leftmost of the first data pads 179a shown in FIG. 5) is connected to the gate driver 400 and transmits signals for driving to the gate driver 400. In such a case, if the gate driver 400 may be integrated in the peripheral areas 320M and 320S, pads and signal lines for transmitting signals may be provided at an opposite side (i.e. rightmost side) of the FPC 650.

Additionally, the second output lines 360b extending toward the subsidiary panel unit 300S from the output pads 710 are connected to second data pads 179b via through holes VH. The through holes VH electrically connect wires disposed at different sides of the IC 700 to each other. Moreover, disposition of the second output lines 360b at the front side prevents intersecting with the input lines 370 on the back side. Of course, if the wires do not intersect each other, they may be disposed at a same side.

A portion of the second data pads 179b are represented on the subsidiary panel unit 300S, and a number of the second data pads 179b may be determined in accordance with a resolution of the display device. For example, when the resolution of the main panel unit 300M is QVGA (320×240) and that of the subsidiary panel unit 300S is QQVGA (160×120), 480 (=160×3) second data pads 179b are provided. In an exemplary embodiment, a number of the first data pads 179a is greater than a number of the second data pads 179b.

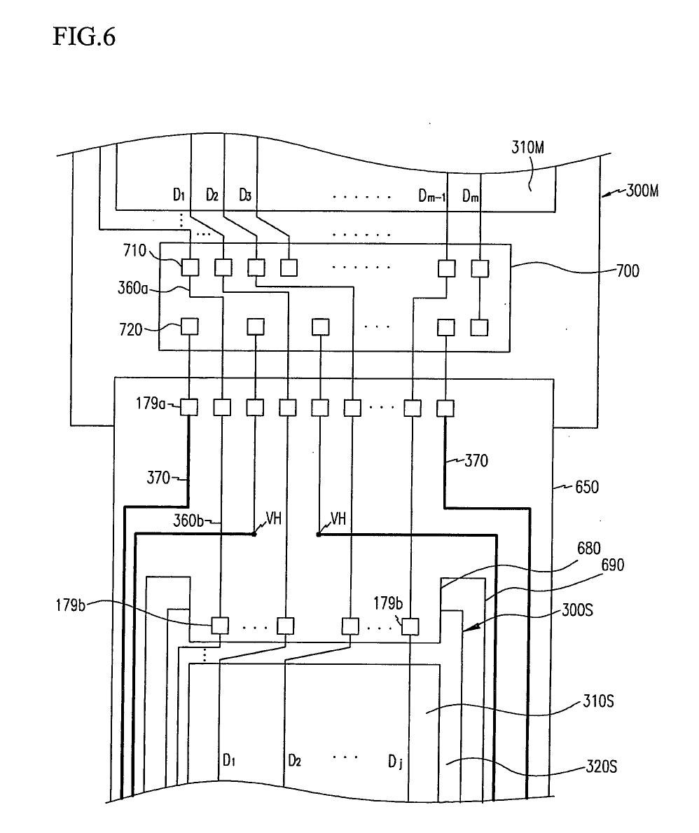

Additionally, although FIG. 6 shows that the second output lines 360b toward the subsidiary panel unit 300S share a portion of the output pads 710 with the first output lines 360a toward the main panel unit 300M, alternatively, separate pads for connection of the second output lines 360b toward the subsidiary panel unit 300S may be provided.

A panel unit according to another exemplary embodiment of the present invention will now be described with reference to FIG. 6.

FIG. 6 is an enlarged view of the display device shown in FIG. 2. Among signal lines shown in the FPC 650, thick solid lines represent signal lines disposed on the front side and thin solid lines represent signal lines disposed on the back side of the FPC 650, as shown in FIG. 5. Further, it is noted that the thickness of the signal lines disposed on the front and back sides is not necessarily different.

The input pads 720 and the output pads 710 are disposed in the area of the IC 700. Input lines 370 are connected to the input pads 720 and transmit the signals from the connector 660 shown in FIG. 2 to the input pads 720.

The data lines D1-Dm, first output lines 360a and a signal line connected to the gate driver 400 are connected to the output pads 710. The first output lines 360a extend toward the subsidiary panel unit 300M and are connected to the first data pads 179a that are not connected to input lines 370. Further, second output lines 360b are disposed between the first data pads 179a and the second data pads 179b to transmit signals from the IC 700 to the subsidiary panel unit 300S. The signal line connected to the gate driver 400 transmits signals for driving to the gate driver 400. In such a case, like the embodiment shown in FIG. 5, if the gate driver 400 may be integrated in the peripheral areas 320M and 320S, separate pads and signal lines for transmitting signals may be provided.

In the meantime, in order to prevent some of the input lines 370 shown with a thick solid line from intersecting the second output lines 360b, either one of the input lines 370 and the second output lines 360b is disposed on a different side of the FPC 650. For example, when the input lines 370 are disposed on the front side of the FPC 650, the second output lines 360b may be disposed on the back side of the FPC 650. Although FIG. 6 shows that the input lines 370 are disposed on the front side of the FPC 650, the input lines 370 may be disposed on the back side of the FPC 650. In such a case, some of the input lines 370 may be disposed on the front side, and the others may be disposed on the back side, which are electrically connected to each other via through holes VH.

Only a portion of the second data pads 179b are represented on the subsidiary panel unit 300S, and a number thereof may be determined in accordance with resolution, as described above.

Further, although FIG. 6 shows that the output lines 360a extending toward the subsidiary panel unit 300S share a portion of the output pads 710 with the data lines D1-Dm, alternatively, separate pads for connection of the output lines 360a may be provided.

Operation of the display device will now be described more in detail referring to FIG. 3.

The signal controller 600 receives, from an external graphic controller (not shown), image signals R, G, and B and input control signals for controlling a display of the panel unit 300. The input control signals may be exemplified by a vertical synchronization signal Vsync, a horizontal synchronization signal Hsync, a main clock CLK, and a data enable signal DE. The signal controller 600 generates gate control signals CONT1 and data control signals CONT2 and processes the image signals R, G, and B to be suitable for operation of the panel unit 300 responsive to the image signals R, G and B and the input control signals. Subsequently, the signal controller 600 sends the gate control signals CONT1 to the gate driver 400, and sends the data control signals CONT2 and the processed image signals DAT to the data driver 500. The signal controller 600 may receive different signals in accordance with a state of a mobile phone etc. mounting the display device, and, according thereto, may send a signal for selecting either of the main panel unit 300M and the subsidiary panel unit 300S. Alternatively, selection of the main and subsidiary panel units 300M and 300S may be made by other means.

The gate control signals CONT1 include a vertical synchronization start signal STV that notifies the gate driver 400 of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD for instructing the data driver 500 to apply the data voltages to the data lines D1-Dm, and a data clock signal HCLK. In the LCD device shown in FIG. 4, the data control signals CONT2 may include an inversion control signal RVS for reversing a polarity of the data voltages (with respect to the common voltage Vcom), The data driver 500 receives a packet of the processed image signals DAT for a pixel row from the signal controller 600 sequentially and converts the processed image signals DAT into analog data voltages selected from the gray voltages supplied by the gray voltage generator 800 in response to the data control signals CONT2 from the signal controller 600. Thereafter, the data driver 500 applies the data voltages to the data lines D1-Dm.

Responsive to the gate control signals CONT1 from the signals controller 600, the gate driver 400 applies the gate-on voltage Von to the gate line G1-Gn, thereby turning on the switching elements Q connected thereto. The data voltages applied to the data lines D1-Dm are supplied to the pixels through the activated switching elements Q.

In the LCD device shown in FIG. 4, a difference between the data voltage and the common voltage Vcom applied to a pixel is expressed as a charged voltage of the LC capacitor C_{LC}, i.e., a pixel voltage. Liquid crystal molecules disposed in the LC layer 3 have orientations responsive to a magnitude of the pixel voltage and the orientations determine a polarization of light passing through the LC capacitor C_{LC}. Polarizers convert light polarization into light transmittance.

By repeating this procedure by a unit of a horizontal period (which is indicated by 1H and equal to one period of the horizontal synchronization signal Hsync), all gate lines G1-Gn are sequentially supplied with the gate-on voltage Von during a frame, thereby applying the data voltages to all pixels. When a next frame starts after finishing one frame, the inversion control signal RVS applied to the data driver 500 is controlled such that the polarity of the data voltages is reversed (which is called “frame inversion”). The inversion control signal RVS may be also controlled such that the polarity of the data voltages flowing in a data line in one frame are reversed (which is called “column inversion” or “dot inversion”), or the polarity of the data voltages in one packet are reversed (which is called “row inversion” or “dot inversion”).

As described above, it is possible to simplify a manufacturing process by disposing both the IC 700 and the subsidiary panel unit 300S on only one FPC 650, and also to lower a manufacturing cost by reducing a number of elements.

Further, it is possible to reduce manufacturing cost and to simplify a manufacturing process and to omit a blind area for connection of the subsidiary panel unit 300S by the main panel unit 300M and the subsidiary panel unit's 300S sharing one FPC 650, thereby providing a small sized display device having high resolution.

While the present invention has been described in detail with reference to exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a circuit board provided with signal lines;
a first panel unit and a second panel unit separately attached to the circuit board, the first and second panel units each being provided with pixels comprising switching elements; and
a driving circuit chip mounted on the circuit board and driving the first and the second panel units.

2. The display device of claim 1, wherein the first and the second panel units comprise gate lines transmitting gate signals, data lines transmitting data lines and a gate driver generating the gate signals, the gate and data lines and the gate driver being integrated in each of the first and the second panel units.

3. The display device of claim 1, wherein the first and second panel units comprise gate lines transmitting gate signals and data lines transmitting data signals, and the driving circuit chip comprises a data driver generating the data signals and a signal controller generating control signals for controlling the data driver.

4. The display device of claim 3, wherein the driving circuit chip further comprises a gray voltage generator generating gray voltages.

5. The display device of claim 1, wherein the circuit board has an aperture, and the second panel unit is exposed through the aperture.

6. The display device of claim 5, wherein the circuit board comprises a projection projecting into the aperture, and the second panel unit is attached to the projection.

7. The display device of claim 1, wherein the circuit board is a flexible printed circuit board.

8. The display device of claim 1, wherein the display device is a liquid crystal display device.

9. The display device of claim 1, wherein the switching element of each of the pixels is comprised of poly-silicon.

10. The display device of claim 1, wherein the switching element of each of the pixels is comprised of amorphous silicon.

11. A display device comprising:
a circuit board provided with signal lines;
a first panel unit and a second panel unit separately attached to the circuit board and each provided with pixels comprising switching elements; and
a driving circuit chip mounted on the circuit board and driving the first and the second panel units,
wherein, the circuit board comprises:
a first pad group disposed in an overlapping area of the first panel unit and the circuit board;
a second pad group and a third pad group each disposed in an overlapping area of the driving circuit chip and the circuit board; and
a fourth pad group disposed in an overlapping area of the second panel unit and the circuit board, and the second pad group is connected to the first pad group and a portion of the second pad group is connected to the fourth pad group.

12. The display device of claim 11, wherein the circuit board comprises:
a first through hole and a second through hole;
a first wire disposed between the first pad group and the first through hole;
a second wire disposed between the first through hole and the second pad group;
a third wire disposed between the second pad group and the second through hole; and
a fourth wire disposed between the second through hole and the fourth pad group.

13. The display device of claim 12, wherein the second and the third wires are disposed at a different side of the circuit board than a side where the first and the fourth wires are disposed.

14. The display device of claim 12, wherein a number of the first pad group is larger than a number of the fourth pad group.

15. The display device of claim 11, wherein the first and the second panel units comprise gate lines transmitting gate signals, data lines transmitting data signals and a gate driver generating the gate signals, the gate and data lines and the gate driver being integrated in each of the first and the second panel units.

16. The display device of claim 11, wherein the first and the second panel units each comprise gate lines transmitting gate signals and data lines transmitting data signals, and the driving circuit chip comprises a data driver generating the data signals and a signal controller generating control signals for controlling the data driver.

17. The display device of claim 16, wherein the driving circuit chip further comprises a gray voltage generator generating gray voltages.

18. The display device of claim 11, wherein the circuit board has an aperture, and the second panel unit is exposed through the aperture.

19. The display device of claim 18, wherein the circuit board comprises a projection projecting into the aperture, and the second panel unit is attached to the projection.

20. The display device of claim 11, wherein the circuit board is a flexible printed circuit board.

21. The display device of claim 11, wherein the display device is a liquid crystal display device.

22. The display device of claim 11, wherein the switching element of each of the pixels is comprised of poly-silicon.

23. The display device of claim 11, wherein the switching element of each of the pixels is comprised of amorphous silicon.

24. A display device comprising:
a circuit board provided with signal lines;
a first panel unit and a second panel unit separately attached to the circuit board and each provided with pixels comprising switching elements; and
a driving circuit chip mounted on the circuit board and driving the first and the second panel units,
wherein, the circuit board comprises:
a first pad group disposed in an overlapping area of the first panel unit and the circuit board;
a second pad group and a third pad group disposed in an overlapping area of the driving circuit chip and the circuit board; and
a fourth pad group disposed in an overlapping area of the second panel unit and the circuit board, and a portion of the third pad group is connected to the fourth pad group.

25. A display device comprising:
a circuit board provided with signal lines;
a first panel unit and a second panel unit separately attached to the circuit board and each provided with pixels comprising switching elements; and
a driving circuit chip mounted on the first panel unit and driving the first and the second panel units.

26. The display device of claim 25, wherein the driving circuit chip comprises a first pad group and a second pad group, and the circuit board comprises:
a third pad group disposed in an overlapping area of the first panel unit and the circuit board; and
a fourth pad group disposed in an overlapping area of the second panel unit and the circuit board, and a portion of the third pad group is connected to a portion of the first pad group and all of the fourth pad group.

27. The display device of claim 26, wherein the third pad group comprises a fifth pad group connected to the second pad group and a sixth pad group commonly connected to the first and the fourth pad groups.

28. The display device of claim 27, wherein the circuit board comprises first wires transmitting signals from an external device to the fifth pad group and second wires transmitting signals from the sixth pad group to the fourth pad group, and the first wires and the second wires are disposed at different sides of the circuit board from each other.

29. The display device of claim 28, wherein the first and the second panel units each comprise gate lines transmitting gate signals, data lines transmitting data signals, and a gate driver generating the gate signals, the gate and data lines and the gate driver being integrated in each of the first and the second panel units.

30. The display device of claim 25, wherein the first and the second panel units comprise gate lines transmitting gate signals and data lines transmitting data signals, and the driving circuit chip comprises a data driver generating the data signals and a signal controller generating control signals for controlling the data driver.

31. The display device of claim 30, wherein the driving circuit chip further comprises a gray voltage generator generating gray voltages.

32. The display device of claim 25, wherein the circuit board has an aperture, and the second panel unit is exposed through the aperture.

33. The display device of claim 32, wherein the circuit board comprises a projection projecting into the aperture, and the second panel unit is attached to the projection.

34. The display device of claim 25, wherein the circuit board is a flexible printed circuit board.

35. The display device of claim 25, wherein the display device is a liquid crystal display device.

36. The display device of claim 25, wherein the switching element of each of the pixels is comprised of poly-silicon.

37. The display device of claim 25, wherein the switching element of each of the pixels is comprised of amorphous silicon.

38. The display device of claim 25, wherein the driving circuit chip comprises a first pad group and a second pad group, and the circuit board comprises:
a third pad group disposed in an overlapping area of the first panel unit and the circuit board; and
a fourth pad group disposed in an overlapping area of the second panel unit and the circuit board, and a portion of the second pad group are connected to the fourth pad group through a portion of the third pad group.
